(19) United States
(12) Patent Application Publication
(10) Pub. No.: US 2007/0288570 A1
(43) Pub. Date: Dec. 13, 2007

(54) Automatic numbering method and system exploiting e-mail

(75) Inventor: Teiji Takeuchi, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/806,740

(22) Filed: Jun. 4, 2007

(30) Foreign Application Priority Data
Jun. 7, 2006 (JP) 2006-158579

(51) Int. Cl. G06F 15/16

(52) U.S. Cl. 709/204

(57) ABSTRACT

A server machine accepting a numbering request by an e-mail is operated in an error-free fashion. The server machine (numbering server) includes numbering management section (mail analysis section 213 and command executing section 214) which analyzes an e-mail sent from a client machine and performs automatic numbering on an electronic numbering ledger based on a numbering command included in the e-mail. The server machine also includes a section for confirming whether or not the e-mail has been sent from the client machine having the right to request the numbering (mail address comparator 215). The numbering request by an e-mail, for which right for requesting the numbering has not been confirmed, is refused irrespective of the numbering command being included in the e-mail.

### RELATED APPLICATION

This application is claiming the priority based on Japanese Patent Application No. 2006-158579 filed on Jun. 7, 2006, the entire disclosure thereof being incorporated herein by reference thereto.

### FIELD OF THE INVENTION

This invention relates to an automatic numbering method for automatically allocating control serial numbers to documents or files, and to a device, a system and a computer program for carrying out the automatic numbering method. More particularly, this invention relates to an automatic numbering method for requesting the control serial numbers to be issued and allocated through e-mails, and to a device, a system and to a computer program for carrying out the method.

### BACKGROUND OF THE INVENTION

Patent Document 1 discloses an automatic numbering method for requesting the serial numbers to be issued and allocated via e-mails. With the computer network, disclosed in the Patent Document 1, even a client machine, located at a remote place, may send an e-mail, stating a numbering command, headed by a symbol for distinguishing the numbering command from the other information, in order to obtain a serial number to be allocated to its document or file,

### [Patent Document 1]

Japanese Patent No. 2699940

### SUMMARY OF THE DISCLOSURE

In the following, analyses are given on the related art by the present invention. The entire disclosure of the aforementioned document is herein incorporated by reference thereto.

With the method disclosed in the Patent Document 1, a wide variety of equipments, having the e-mail function, may be used as client machines. However, the known method suffers from a drawback that it carries out automatic numbering processing irrespective of whether or not the request for numbering is actually requested.

For example, if the same text as the numbering command, inclusive of the aforementioned heading symbol, is included in an e-mail, a server machine of Patent Document 1 erroneously takes it as the numbering request and proceeds to numbering. The sender of the e-mail may be harboring a malignant intention and willfully sending such e-mail. However, the above situation may arise even in the absence of a malignant intention on the part of the sender if the same text as the numbering command is included in a document in, e.g., a marketing mail. Thus there is much to be desired in the art.

In one aspect, the present invention provides an automatic numbering method employing a server machine including a numbering management unit that carries out automatic numbering on an electronic numbering ledger; and a plurality of client machines each of which is capable of sending an e-mail including a numbering command to the server machine. A numbering request from a client machine not having a right to request the numbering may be refused by the server machine.

The server machine confirms whether or not the e-mail is sent from a client machine having the right for requesting the numbering, based on information in the e-mail including the numbering command.

The aforementioned method may be implemented by a computer program that allows execution of processing for confirming whether or not the e-mail has been sent from a client machine having the right to request the numbering based on the information in the e-mail sent from the client machine.

The server machine executes a step of analyzing an e-mail, confirmed to have been sent from a client machine having the right to request the numbering only in case the right for requesting the numbering has been confirmed, registering in the numbering ledger based on the numbering command included in the e-mail, and acquiring the result of automatic sampling. The server machine also executes a step of sending the result of automatic numbering to a client machine as a sender of the e-mail including the numbering command.

Specifically according to a first aspect of the present invention, there is provided a server machine comprising: numbering management unit that analyzes an e-mail sent from a client machine, carries out automatic numbering on an electronic numbering ledger based on a numbering command included in the e-mail, and sends a result of numbering to the client machine as a sender of the e-mail including the numbering command;

the server machine comprising:

a confirmation unit that confirms whether or not the e-mail is sent from a client machine having a right for requesting the numbering, based on the information in the e-mail including the numbering command;

wherein a request for numbering from a client machine not having the right for requesting the numbering is refused.

The server machine may confirm whether or not there is the right for requesting the numbering depending on whether or not the mail address of the sender of the e-mail is a pre-registered mail address.

The server machine may further confirm whether or not there is the right for requesting the numbering depending on whether or not the e-mail includes an ID issued beforehand.

In the server machine, a term of validity may be set for the ID; and

a numbering request with an ID expired may be refused.

The server machine according may further comprise:

an extracting unit that extracts items of registration for the numbering ledger, stated in a preset form in the e-mail including the numbering command, and for registering the extracted items of registration in the numbering ledger.

According to a second aspect, there is provided a business system including a server machine according to the first aspect, and a plurality of client machines each of which is capable of sending an e-mail including a numbering command to the server machine;

the business system monistically managing a document or a file by an automatic numbering function.

According to a third aspect, there is provided an automatic numbering method comprising:

providing a server machine including a numbering management unit that carries out automatic numbering for an electronic numbering ledger; and

providing a plurality of client machines each of which is capable of sending an e-mail including a numbering command to the server machine;

confirming, by the server machine, whether or not an e-mail sent from a client machine is sent from a client machine having a right to request the numbering, based on information included in the e-mail;

analyzing, by the server machine, an e-mail sent from the client machine confirmed to have been sent from the client machine having the right to request the numbering, and registering on the numbering ledger based on the numbering command in the e-mail to acquire the result of automatic numbering; and

sending, by the server machine, the result of automatic numbering to the client machine as the sender of the e-mail including the numbering command; provided that a numbering request from a client machine not having the right to request the numbering is refused.

According to a fourth aspect, there is provided a numbering management program, the program allowing a server machine, connected to a plurality of client machines, each of which is capable of transmitting an e-mail including a numbering command, to perform a processing comprising:

analyzing an e-mail transmitted from one of the client machines, registering in the numbering ledger based on a numbering command contained in the e-mail; and

acquiring the result of automatic numbering, and a processing of sending the result of the automatic numbering to the client machine as the sender of the e-mail including the numbering command; wherein

the program further comprises: confirming whether or not an e-mail sent from a client machine has been sent from a client machine having a right to request numbering, based on information included in the e-mail sent from the client machine; wherein

only an e-mail confirmed to have been sent from the client machine having the right to request the numbering is analyzed, provided that a request for numbering from a client machine not having the right to request the numbering is refused.

The meritorious effects of the present invention are summarized as follows.

According to the present invention, an E-mail, which is not to be numbered automatically, may be excluded from the subject of the automatic numbering to accept only legitimate numbering requests. This is made possible by the configuration in which the server machine in proceeding to automatic numbering processing confirms the right for requesting the numbering based on the information included in the e-mail.

### BRIEF DESCRIPTION OF THE DRAWINGS

FIG. 1 is a schematic view showing the constitution of a business system (document registration system) according to a first example of the present invention.

FIG. 2 is a schematic view showing the detailed constitution and operations of a server machine according to the first example of the present invention.

FIG. 3 is a schematic view showing the detailed constitution and operations of a device usable as a client machine.

FIG. 4 is a schematic view showing a typical e-mail for requesting the numbering to a server machine according to the first example of the present invention.

FIGS. 5A, 5B and 5C are schematic views showing automatic numbering for a numbering ledger according to the first example of the present invention.

FIG. 6 is a schematic view showing the constitution of a business system (document registration system) according to a second example of the present invention.

FIG. 7 is a schematic view showing the detailed constitution and operations of a server machine (ID issuing server) according to the second example of the present invention.

FIG. 8 is a schematic view showing the detailed constitution and operations of a server machine (numbering server) according to the second example of the present invention.

FIG. 9 is a schematic view showing a typical e-mail sent from the server machine (ID issuing server) to a client machine according to the second example of the present invention.

FIG. 10 is a schematic view showing a typical e-mail sent from the server machine (ID issuing server) to a server machine (numbering server) according to the second example of the present invention.

FIG. 11 is a schematic view showing a typical e-mail sent for requesting the numbering from the server machine (numbering server) according to the second example of the present invention.

FIGS. 12A, 12B and 12C are diagrammatic views for illustrating schematics of the automatic numbering for the numbering ledger in the second example of the present invention.

FIG. 13 is a schematic view showing the detailed constitution and the operation of a server machine of the related art (Patent Document).

### PREFERRED MODES OF THE INVENTION

### FIRST EXAMPLE

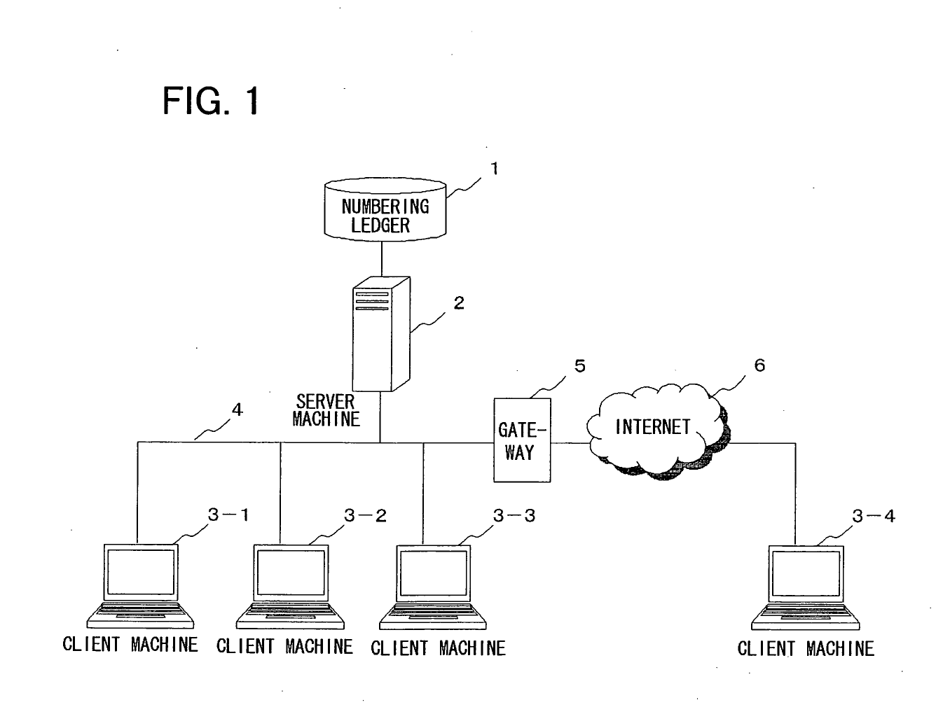

The present invention will now be described with reference to the accompanying drawings. FIG. 1 is a schematic view showing the constitution of a business system (document registration system) according to a first example of the present invention.

Referring to FIG. 1, the business system (document registration system) according to the present example includes a server machine 2, a plural number of client machines 3-1 to 3-4 and a mail server, not shown. The server machine includes an electronic numbering ledger 1 and is run for 24 hours. The client machines make numbering requests to the server machine.

The server 2 and the client machines 3-1 to 3-3 are interconnected over LAN 4 (Local Area Network). The client machine 3-4 is connectable to the server machine 2 over the Internet 6 and a gateway 5.

It is noted that the above-described network configuration is merely illustrative and may be of a variety of unlimited architectures or constitutions, it being sufficient if e-mails can be exchanged between the server machine 2 and the client machines 3-1 to 3-4.

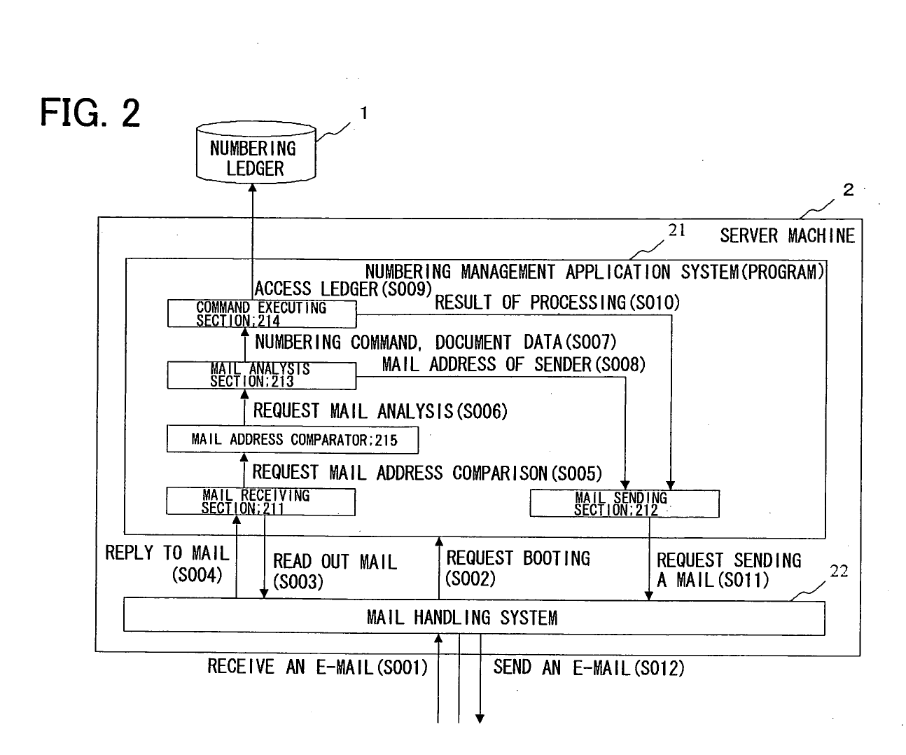

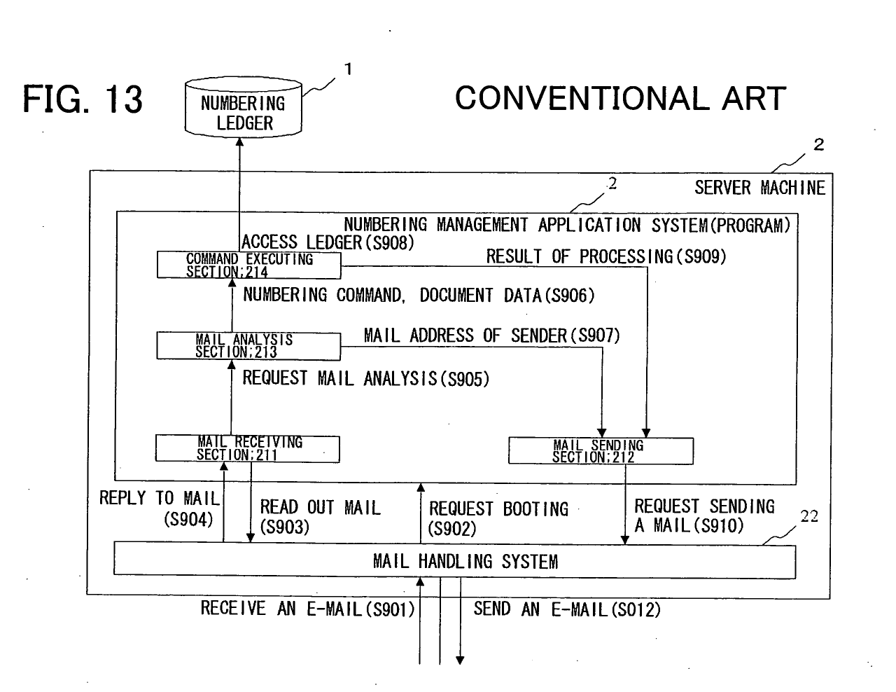

The server machine 2 is now described in detail. FIG. 2 schematically shows the detailed constitution of the server machine 2 and the operation of its various parts. Referring to FIG. 2, the server machine 2 includes a numbering management application system (program) 21 for managing/ running the numbering ledger 1, and a mail handling system 22. The server machine 2 differs from a server machine 2 (FIG. 13) of Patent Document 1 by the fact that the numbering management application system (program) 21 includes a mail address comparator 215, that is, has the function of comparing mail addresses.

The numbering management application system 21 comprises a computer program for running a mail receiving section 211, a mail sending section 212, a mail analysis section 213, a command executing section 214 and the mail address comparator 215 of the server machine 2. The numbering management application program is read out from a memory, not shown, and is run by a CPU of the server machine 2. The mail analysis section 213 and the command executing section 214 form a numbering management unit (not shown), while the mail address comparator 215 forms a mail address confirmation unit.

The-mail handling system 22 is run for all time to deliver e-mails, sent from the client machines 3-1 to 3-4, to the numbering management application system 21, and to transmit the e-mails responsive to requests from the numbering management application system 21.

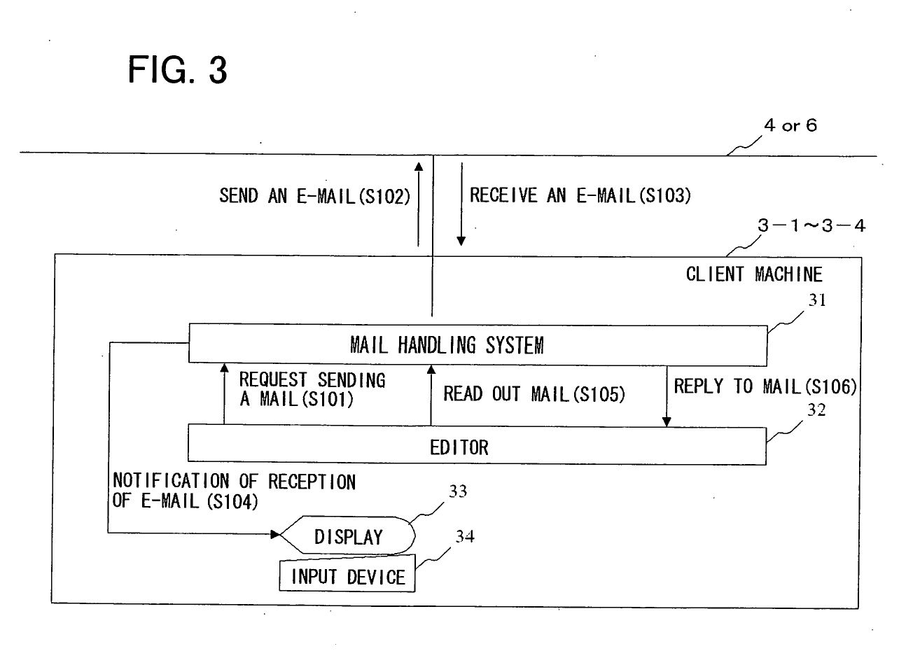

The detailed constitution of the client machine 3 is now described. FIG. 3 schematically shows the detailed constitution of the client machine 3 and the operations of its various parts. Referring to FIG. 3, the client machine 3 includes a mail handling system 31 for sending/receiving e-mails, an editor 32 for formulating e-mails, a display 33, such as a liquid crystal display (LCD), and an inputting device 34, such as a keyboard.

The-mail handling system 31, and the editor 32, configured for preparing e-mails, may comprise a software installed in any of various devices, constituting the client machine 3, such as a personal computer, PDA (Personal Digital Assistant) or a mobile phone.

It is sufficient if the numbering ledger 1 used is able to store the numbering information. For example, a file on an external memory or a commercial database may be used as the numbering ledger. To prevent garbling of letter—or word data, liable to occur in data transfer between different networks, ASCII or Unicode base files or databases are preferably used. The numbering ledger 1 may also be established (stored) in, e.g., an enclosed disc of a server machine.

The case of numbering, that is, acquiring a management number of a document prepared on an editor 32 of the client machine 3-4, is now described with reference to FIGS. 2 and 3, by way of describing the operation of the present example.

A user of the client machine 3-4 prepares an e-mail for requesting the numbering in the editor 32 to request the-mail handling system 31 to send the-mail (S101 of FIG. 3).

The mail handling system 31, which has accepted the request to send the e-mail to the server machine 2, via editor 32, sends the e-mail to the server machine 2 (S102 of FIG. 3).

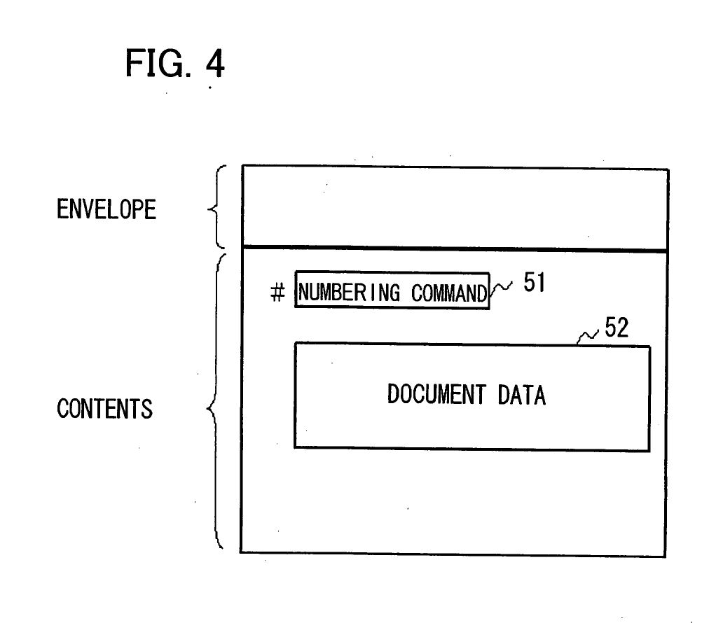

FIG. 4 shows an exemplary e-mail for requesting the numbering to the server machine 2. Referring to FIG. 4, the e-mail is made up of an envelope and contents. The envelope states a mail address of the server machine 2, as destination of transmission, a mail address of the client machine 3-4, as a sender, and the sending date.

A body part of the contents of FIG. 4 comprises a numbering command 51 and document data 52. The numbering command 51 requests numbering to the server machine 2. The numbering command is headed by a preset symbol, # in the example of FIG. 4, for distinction from the other information of the contents. The document data 52 is prepared by the user and is the object of allocation of the serial number, that is, the contents (items) of registration of the numbering ledger.

The numbering command 51 and the document data 52 are preferably written in ASCII or Unicode, for the same reason as that set forth above for the numbering ledger 1. Alternatively, a letter/character code conversion mechanism may be provided on the server.

The E-mail is distributed to the server machine 2 over the Internet 6, gateway 5 and LAN 4.

On receipt of the e-mail from the client machine 3-4 (S001 of FIG. 2), the mail handling system 22 of the server machine 2 boots the numbering management application system 21, responsive to this receipt (S002 of FIG. 2).

On booting of the numbering management application system 21, the mail receiving section 211 performs mail readout processing for the mail handling system 22 (S003 of FIG. 2), and receives the e-mail, sent from the client machine 3-4, through the mail handling system 22 (S004 of FIG. 2).

The mail receiving section 211 delivers the e-mail, received from the mail handling system 22, to the mail address comparator 215, to request comparison of the mail address of the client machine 3-4, as a sender, to a pre-registered mail address, that is, a mail address of an owner of the right for requesting the numbering (SO05 of FIG. 2).

If the mail address of the e-mail, received from the mail receiving section 211, coincides with the pre-registered mail address (mail address of the owner of the right for requesting the numbering), the mail address comparator 215 delivers the received e-mail to the mail analysis section 213 to request analysis (S006 of FIG. 2).

If conversely the mail address of the e-mail received is not coincident with the pre-registered mail address (mail address of the owner of the right for requesting the numbering), that is, the right for requesting the numbering is not confirmed, the numbering management application system 21 is terminated at this time point.

On receipt of an e-mail analysis request, the mail analysis section 213 extracts the numbering command 51 in the contents of the e-mail, based on a preset symbol (herein #). The mail analysis section sends the so extracted numbering command 51 and other data stated in the contents (document data 52) to the command executing section 214 (S007 of FIG. 2).

The mail analysis section 213 also notifies the mail sending section 212 of the mail address of the sender of the e-mail in question, in readiness for returning, by an e-mail, the results of processing (results of numbering) by the command executing section 214, to the client machine 3-4, as the source of the numbering request in question (S008 of FIG. 2).

The command executing section 214, which has received the numbering command 51 and the document data 52 from the mail analysis section 213, accesses the numbering ledger 1 to determine a management number next following the last one of the registered serial management numbers. The command executing section 214 generates a new record (R) including the so determined management number and the document data delivered from the mail analysis section 213 to register the record in the numbering ledger 1 (S009 of FIG. 2).

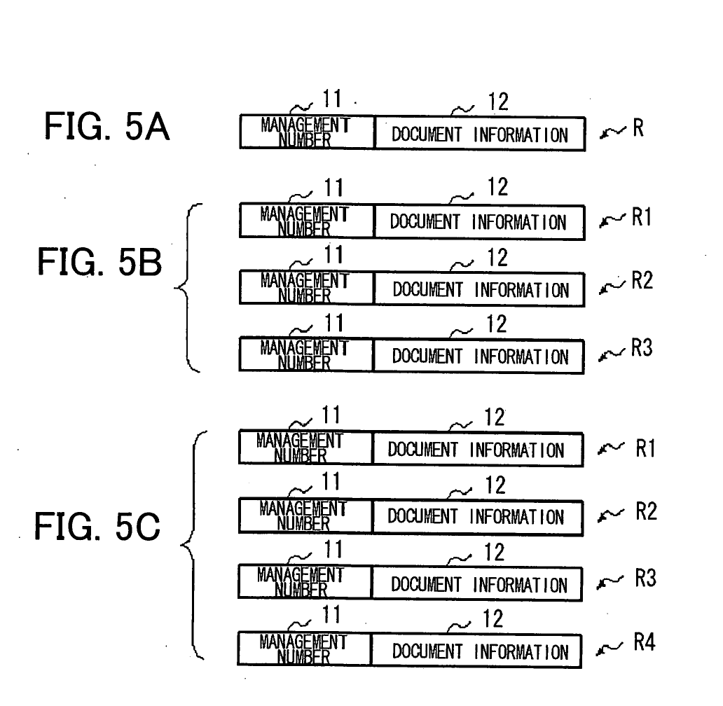

FIGS. 5A-5C are diagrams showing schematics of automatic numbering processing by the command executing section 214 on the numbering ledger 1. FIG. 5A shows the items of the sole record (R) additionally registered by the above step S009. The sole record (R) includes at least a management number 11 and the document (text) information 12, as described above.

Suppose that three records R1 to R3, specified by serial numbers 1, 2 and 3, respectively, are registered at a given time point in the electronic numbering ledger 1, as shown in FIG. 5B. The command executing section 214 gets the number ‘4’, next following the last management number ‘3’, to generate a new record R4, and registers it in the numbering ledger 1, as shown in FIG. 5C.

When the above-described automatic numbering processing has come to a close, the command executing section 214 notifies the mail sending section 212 of the presently obtained management number as the result of processing, that is, as the result of numbering (S010 of FIG. 2).

On receipt of the result of processing or the result of numbering, the mail sending section 212 formulates an e-mail addressed to the mail address of the sender (source of the numbering request), notified from the mail analysis section 213, that is, the mail address of the client machine 3-4, as the destination. The body part of the contents of the e-mail states the result of processing, that is the result of numbering (management number), notified from the command executing section 214. The mail sending section requests the mail handling system 22 to send an e-mail communicating the result of the automatic numbering (S011 of FIG. 2).

On receipt of the request for sending the e-mail, stating the result of the automatic numbering, the mail handling system 22 sends the e-mail, requested to be sent from the mail sending section 212 (S012 of FIG. 2). The e-mail, stating the result of the automatic numbering, is sent to the client machine 3-4 through the LAN 4, gateway 5 and the Internet 6.

On receipt of the e-mail from the server machine 2 (S103 of FIG. 3), the mail handling system 31 of the client machine 3-4 demonstrates a notification of receipt of the e-mail on the display 33 (S104 of FIG. 3).

The user may read the e-mail, received by the mail handling system 31, using the editor 32 (S105 and S106 of FIG. 3), to confirm the result of the numbering (management number) on the display 33.

The above is the operation for the case where a numbering request is from the client machine 3-4. The numbering request may be made in similar manner from the other client machines 3-1 to 3-3 as well.

Moreover, in the present example, the serial management numbers may be allocated automatically only to document data for which the right for requesting the numbering has been confirmed by the mail address of the sender of the e-mail in question. This has tremendous practical merits because it becomes possible in this case to preclude e-mails sent at random by parties with malignant intention or marketing e-mails sent by unrelated corporations even without malignant intentions.

In addition, similarly to Patent Document 1, the present example exploits the merits proper to the e-mail system that numbering may be made for client machines with which the server machine 2 may exchange e-mails. By exploiting the merits of the e-mail system, the client machines may be of machine architectures different from that of the server machine 2 or may also be located in remote places. In the case of the client machines located in remote places, e-mails may be exchanged over a variety of networks having different network architectures, in a known manner.

### SECOND EXAMPLE

Referring to the drawings, a second example of the present invention, modified from the above-described first example, is now described. In the second example, the right for the numbering request is confirmed more rigorously with the use of a fixed-term ID. In the following description, what has already been explained in the first example is sometimes dispensed with.

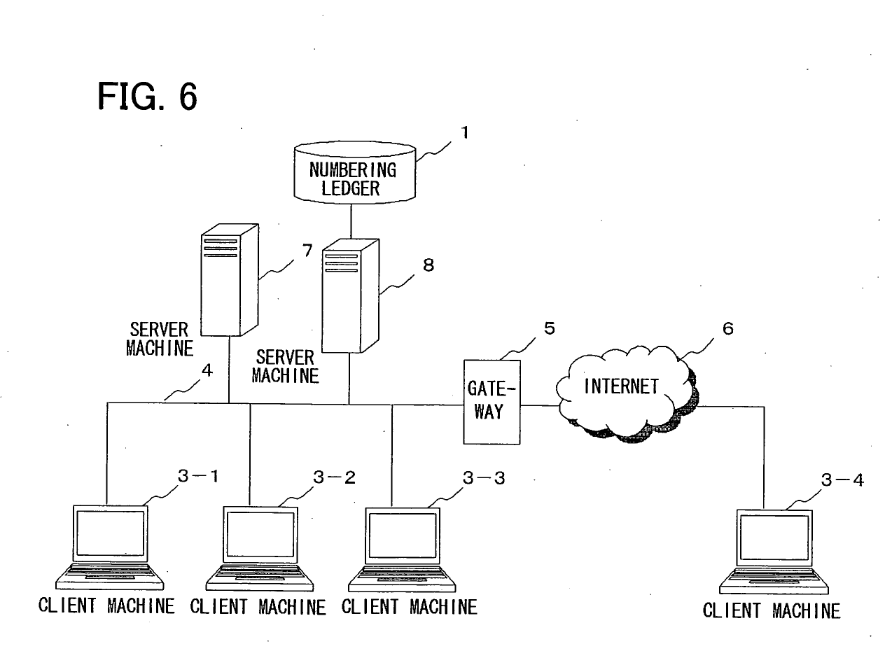

FIG. 6 is a schematic view showing a constitution of a business system (document registration system) according to a second example of the present invention. Referring to FIG. 6, the business system (document registration system) of the present example includes a first server machine 7 and a second server machine 8, in place of the server machine 2 of the first example. The first server machine 7 accepts a request for issuance of an application form inclusive of a fixed-term ID. The second server machine 8 includes a numbering ledger 1 and is run for 24 hours. It is noted that the first and second server machines 7, 8 are run for 24 hours and, in this respect, the present example is similar to the above-described first example.

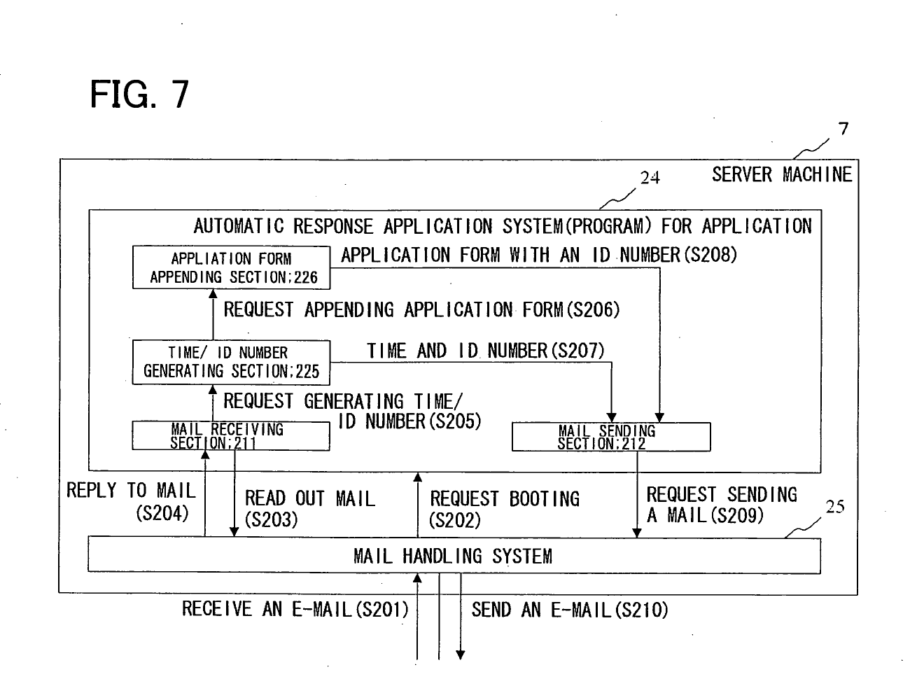

The detailed constitution of the server machine 7 is now described. FIG. 7 shows a detailed constitution and the operation of various portions of the server machine 7. Referring to FIG. 7, the server machine 7 includes an automatic response application system (program) for application 24 for replying to a request for an application form, and a mail handling system 25.

The automatic response application system for application 24 comprises a computer program for running a mail receiving section 211, a mail sending section 212, a time/ID number generating section 225 and an application form appending section 226 of the server machine 7. The automatic response application program for application is read out from a memory, not shown, and is run on a CPU of the server machine 7.

Similarly to the mail handling system 22 of the server machine 2 of the first example, the mail handling system 25 is run for all time to deliver e-mails sent from the client machines 3-1 to 3-4 to the automatic response application system for application 24 and to send e-mails responsive to a request from the automatic response application system for application 24.

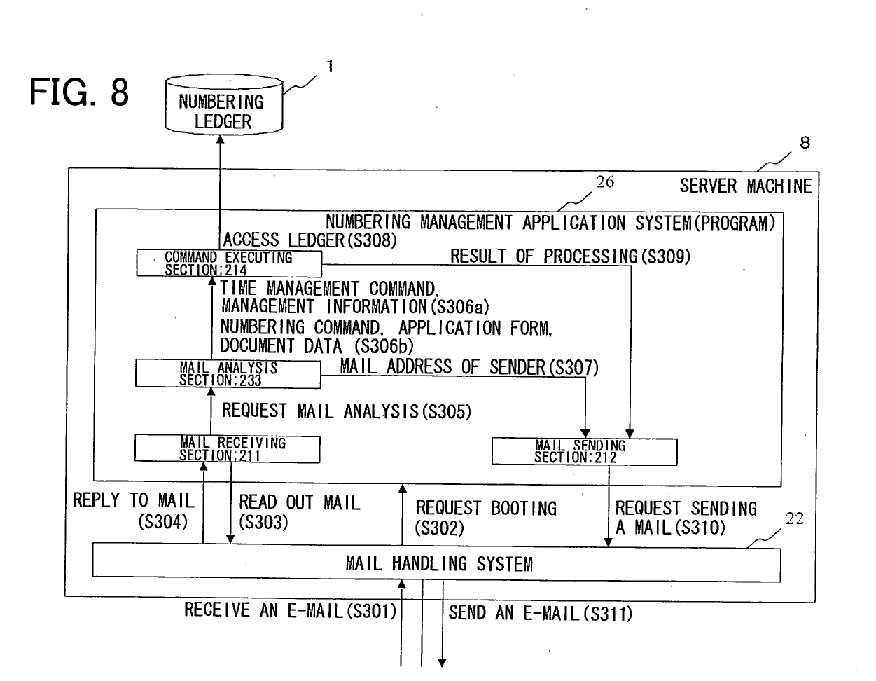

The detailed constitution of the server machine 8 is now described. FIG. 8 schematically shows the detailed constitution and the operation of various parts of the server machine 8. Referring to FIG. 8, the server machine 8 includes a numbering management application system (program) 26 for managing/ running the numbering ledger 1, and a mail handling system 22. The server machine 8 differs from the server machine 2 in the following respects. First, the numbering management application system (program) 26 is not provided with a mail address comparator 215, that is, is not provided with the function of comparing mail addresses. Second, a mail analysis section 233 is provided with the function of confirming the right for requesting the numbering based on the information received from the server machine 7 (ID information and the time information).

The case of numbering, that is, getting a management number of, a document prepared by the editor 32 of the client machine 3-4, as in the first example, is now described with reference to FIGS. 3, 7 and 8, by way of describing the operation of the present example.

A user of the client machine 3-4 formulates, by the editor 32, an e-mail for requesting an application form with an ID number for numbering, from the server machine 7, and requests the mail handling system 31 to send the mail (step S101 of FIG. 3).

On accepting the request for transmitting the e-mail through the editor 32, the mail handling system 31 sends the e-mail to the server machine 7 (S102 of FIG. 3).

It is sufficient that the e-mail to the server machine 7 is recognizable by the server machine 7. For example, the e-mail may be a so-called blank mail devoid of the text.

On receipt of the e-mail from the client machine 3-4 (S201 of FIG. 7), the mail handling system 25 of the server machine 7 boots the automatic response application system (program) for application 24 (S202 of FIG. 4), with the receipt of the mail as an incentive.

When the automatic response application system (program) for application 24 is booted, the mail receiving section 211 reads out the mail for the mail handling system 25 (S203 of FIG. 7) and receives the e-mail transmitted from the client machine 3-4 via mail handling system 25 (S204 of FIG. 7).

The mail receiving section 211 delivers the e-mail received to the time/ID number generating section 225 to request generating a time/ID number (S205 of FIG. 7).

The time/ID number generating section 225 delivers the e-mail received, and an ID number, generated at random, to the application form appending section 226, to request appendage of an application form (S206 of FIG. 7).

The time/ID number generating section 225 sends the ID number and the year, month, date data as well as time data of the request, delivered to the application form appending section 226, to the mail sending section 212 in advance (S207 of FIG. 7).

The application form appending section 226, which has received the e-mail and the ID number from the time/ID number generating section 225, generates an application form inclusive of an ID number.

The application form appending section 226 extracts the mail address of the client machine 3-4, from the e-mail received from the time/ID number generating section 225, and delivers the so extracted mail address to the mail sending section 212 (S208 of FIG. 7), along with the aforementioned application form including the ID number (S208 of FIG. 7).

From the application form appending section 226, the mail sending section 212 formulates an e-mail, addressed to the mail address of the source of request of the application form (mail address of the client machine 3-4), and having the application form with the ID number appended to the body part of the contents of the e-mail, and requests the mail handling system 25 to send the e-mail (S209 of FIG. 7).

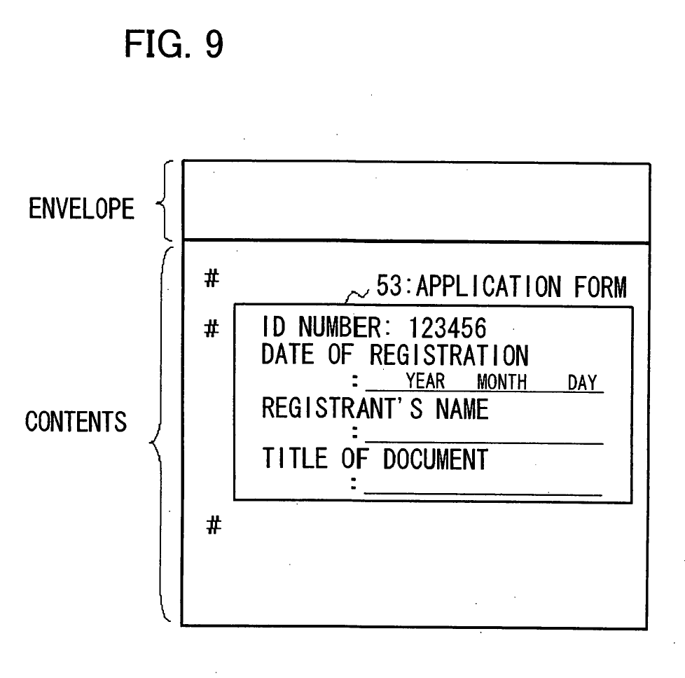

FIG. 9 is a diagram showing a typical e-mail for a client machine, as generated by the mail sending section 212. An envelope of the e-mail states a mail address of the client machine 3-4, as destination, a mail address of the server machine 8, the application form with the ID number is sent to, the sending date and so forth. The body part of the contents of the e-mail states an application form with the ID number 53. Meanwhile, in the example of FIG. 9, a preset symbol, ‘#’ in the example of FIG. 9, is entered at a leading end of a line presumed to state e.g. a numbering command in the contents, a leading end of the application form with the ID number 53, and at a leading end presumed to state document data.

The mail sending section 212 sends an e-mail, stating that the application form inclusive of the ID number has been issued, to the server machine 8.

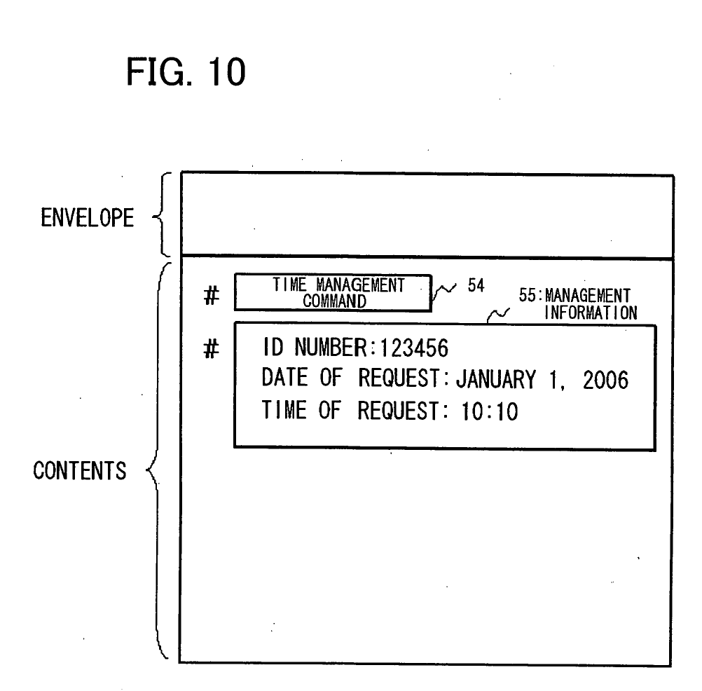

FIG. 10 is a diagram showing a typical e-mail for the server machine 8, as generated by the mail sending section 212. The envelope of the e-mail states a mail address of the server machine 8, as destination, a mail address of the server machine 7, as sender, and the sending date and time. The body part of the contents of the e-mail states the ID number, sent from the time/ID number generating section 225, the management information 55, inclusive of the year, month, date and time of the request, and a time management command 54. It is noted that, in the example of FIG. 10, a preset symbol, ‘#’ in the example of FIG. 10, is again entered at a leading end of each of the time management command and the management information, for distinction thereof from the other information.

The mail handling system 25 sends the above two mails, requested to be sent from the mail sending section 212 (S210 of FIG. 7). These e-mails are sent to the client machine 3-4 and to the server machine 8 according to their destinations.

The processing by the server machine 8, which has received the e-mail, transmitted with the above step S210, is now described. On receipt of the e-mail from the server machine 7 (S301 of FIG. 8), the mail handling system 22 of the server machine 8 boots the numbering management application system (program) 26 (S302 of FIG. 8), with the receipt of the mail as an incentive.

When the numbering management application system (program) 26 is booted, the mail receiving section 211 reads out the mail for the mail handling system 22 (S303 of FIG. 8) and receives the e-mail transmitted from the server machine 7 via mail handling system 22 (S304 of FIG. 8).

The mail receiving section 211 delivers the e-mail, received from the mail handling system 22, to a mail analysis section 233, to request analysis of the e-mail (S305 of FIG. 8).

The mail analysis section 233, requested to analyze the e-mail, extracts the time management command 54 and the management information 55 in the contents of the e-mail, received from the server machine 7, to send them to the command executing section 214 (S306a of FIG. 8).

The command executing section 214 holds the management information 55 for a preset period of time, in accordance with the time management command 54, for confirming the right for requesting the numberings, as later described.

The processing by the client machine 3-4, which has received the e-mail, transmitted in the step S210 of FIG. 7, is now described. On receipt of the e-mail from the server machine 7 (S103 of FIG. 3), the mail handling system 31 of the client machine 3-4 demonstrates a notification of receipt of the e-mail on the display 33 (S104 of FIG. 3).

The user of the client machine 3-4 may read the e-mail, received by the mail handling system 31, using the editor 32 (S105 and S106 of FIG. 3), to edit the e-mail, added by the application form with the ID number, on the display 33.

The user of the client machine 3-4 may add such items as ID number, date and time, name or the title of the registered documents, as necessary, in the application form with the ID number, on the editor 32, to request the mail handling system 31 to send the e-mail (S101 of FIG. 3).

The mail handling system 31, which has accepted the request for sending the e-mail through the editor 32, sends the e-mail to the server machine 8 (S102 of FIG. 3).

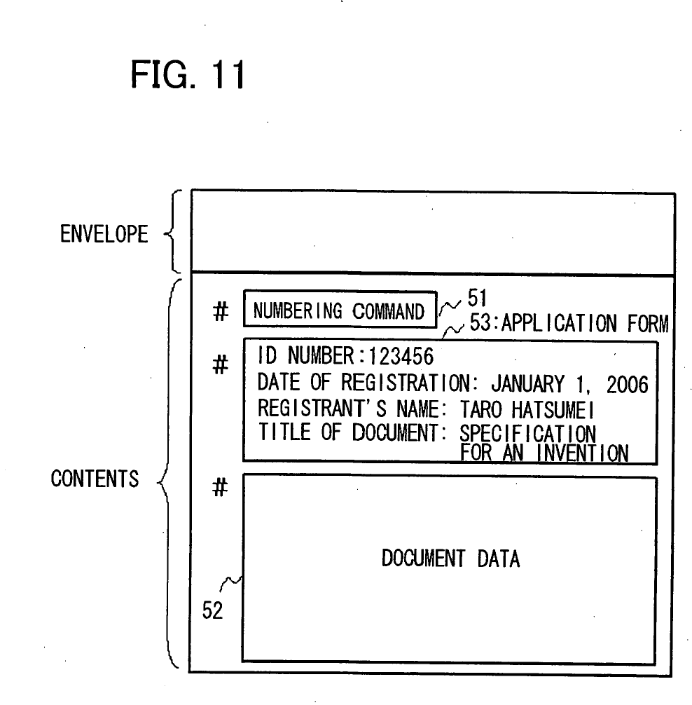

FIG. 11 is a diagram showing a typical e-mail for requesting the numbering by the server machine 8. The point of difference of this e-mail from the e-mail explained in connection with the first example (FIG. 4) is that the body part of the contents of the present e-mail includes the application form 53 with the ID number in which necessary data have been recorded.

The operation on the server machine 8, which has received the e-mail, added by the application form including the ID number 53, is now described. On receipt of the e-mail from the server machine 8 (S301 of FIG. 8), the mail handling system 22 of the server machine 8 boots the numbering management application system (program) 26 (S302 of FIG. 8), with the receipt of the mail as an incentive.

When the numbering management application system (program) 26 is booted, the mail receiving section 211 reads out the mail for the mail handling system 22 (S303 of FIG. 8) and receives the e-mail sent from the client machine 3-4 via mail handling system 22 (S304 of FIG. 8).

The mail receiving section 211 delivers the e-mail, received from the mail handling system 22, to the mail analysis section 233, to request analysis of the e-mail (S305 of FIG. 8).

The mail analysis section 233, requested to analyze the e-mail, extracts the numbering command 51 in the contents of the e-mail, and transmits the so extracted numbering command 51, other data stated in the contents, that is, application form with the ID number 53 and document data 52, and date/time in the envelope, to the command executing section 214 (S306b of FIG. 8).

The mail analysis section 233 notifies the mail sending section 212 of the mail address of the sender of the present e-mail, in readiness for returning the results of processing by the command executing section 214 (result of the numbering) by an e-mail to the client 3-4 as the source of the numbering request (S307 of FIG. 8).

The command executing section 214, which has received the numbering command 51, application form 53 with the ID number and the document data 52 from the mail analysis section 233, first confirms whether or not the management information 55, bearing the same ID number as that stated in the application form with the ID number 53, has been stored.

In case the management information 55, bearing the same ID number as that stated in the application form 53 with the ID number, has been stored, the command executing section 214 compares the sending date and time in the envelope received from the mail analysis section 233, to the year, month, date and time of the request in the management information 55. If the time gap is less than the preset period of time, such as within for 24 hours, the command executing section 214 accesses the numbering ledger 1 to decide on the management number next following the last registered management number. The command executing section formulates a new record (R) including the management number decided on, the data of the documents delivered from the mail analysis section 233 and the items entered in the application form with the ID number, and registers the so formulated new record in the numbering ledger 1 (S308 of FIG. 8).

If the management information 55, bearing the same ID number as that stated in the application form 53 with the ID number, has not been stored, or the management information 55 bearing the same ID number has been stored but transmission has not been made within the preset period of time, the numbering management application program 26 is terminated at this time instant.

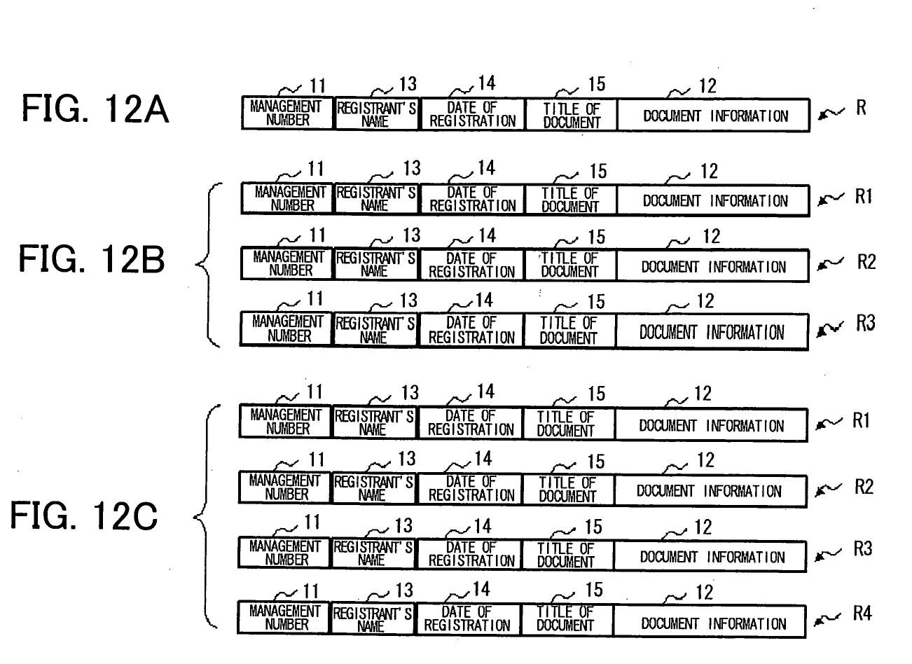

FIGS. 12A, 12B and 12C are diagrams for illustrating schematics of automatic numbering processing for the numbering ledger 1 by the command executing section 214. FIG. 12A shows the contents of a sole record (R) additionally registered in the above step s309. The sole record (R), generated by the server machine 8 of the present example, is made up of a management number 11, a registrant's name 13, year, month and date of registration 14, document title 15 and the document information 12.

In case three records R1 to R3, specified by serial numbers 1 to 3, have been registered at a certain time point, as shown in FIG. 12B, the command executing section 214 sets the number 4, next following the last management number ‘3’, as shown in FIG. 12C. The command executing section generates a new record R4 and registers the so generated record in the numbering ledger 1.

When the above-described automatic numbering has come to a close, the command executing section 214 notifies the mail sending section 212 of the currently obtained management number as being the result of processing (result of numbering) as in the above-described first example (S309 of FIG. 8).

The mail sending section 212 which has received the result of processing (result of numbering) formulates an e-mail, with a mail address of the sender (source of the numbering request), that is, the mail address of the client machine 3-4, as notified from the mail analysis section 233, as destination. The e-mail states, in the body portion of its contents, the result of processing (result of numbering), that is, the management number, notified from the command executing section 214. The mail sending section 212 then requests the mail handling system 22 to send the e-mail communicating the aforementioned result of the automatic numbering (S310 of FIG. 8).

The mail handling system 22, which has received the request for sending the e-mail, communicating the result of the automatic numbering, sends the e-mail, requested to be sent by the mail sending section 212 (S311 of FIG. 8). The e-mail, communicating the result of the automatic numbering, is distributed over the LAN 4, gateway 5 and the Internet 6 to the client machine 3-4.

The ensuing processing is as described above in connection with the first example. That is, the result of the numbering (management number) may be confirmed on the display 33 of the client machine 3-4 on reading out the e-mail received from the server machine 8

The above is the operation for the case where a request for an application form with an ID number and a request for numbering are made from the client machine 3-4. It is noted that a request for an application form with an ID number and the request for numbering may be made in similar manner from the other client machines 3-1 to 3-3 as well.

Moreover, in the present example, in distinction from the above-described first example, the right for requesting the numbering may be confirmed not only from the mail address of the sender, but also from the fixed-term ID, issued by the server machine 7. Thus, it becomes possible to accept only the numbering request made in accordance with a proper sequence of operational steps from a party aware of the mail address of the server machine 7.

The above-described example shows a constitution in which processing is shared (distributed) by two server machines, namely the server machine 7 and the server machine 8. Alternatively, a sole server may carry out the above sequence of operations, provided that the numbering management application program 26 and the automatic response application program for application 24 are loaded in the server and the subject to be booted from the mail handling system on mail receipt is changed depending on two mail addresses, namely a mail address for requesting an application form with an ID number and a mail address for the numbering request. It is possible in this case not to transmit an ID e-mail to the tenor that the application form with the ID number has been issued (see FIG. 10) and to directly transmit the tenor between the automatic response application system (program) for application 24 and the numbering management application system (program) 26.

It is also possible to dispense with the mail handling system 25 and the mail receiving section 211 of the server machine 7 and to have the server machine hold Web contents for requesting an application form with an ID number. In this case, a mail address input and a request for an application form with an ID number are accepted from the web.

Although the present invention has so far been described with reference to preferred examples, the present invention is not to be restricted to the examples. It is to be appreciated that those skilled in the art can change or modify the examples provided that departure is not made from the purport of the invention that a server machine accepting a numbering request by a numbering command in an e-mail (numbering server) refuses the numbering request not having the right for requesting the numbering based on the information contained in the e-mail including the numbering command. In addition, the present invention is not restricted to the document registration system described above and may also be applied to other business systems in need of numbering.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A server machine comprising:
numbering management unit that analyzes an e-mail sent from a client machine, carries out automatic numbering on an electronic numbering ledger based on a numbering command included in said e-mail, and sends a result of numbering to said client machine as a sender of said e-mail including said numbering command;
said server machine comprising:
a confirmation unit that confirms whether or not said e-mail is sent from a client machine having a right for requesting the numbering, based on the information in said e-mail including said numbering command;
wherein a request for numbering from a client machine not having the right for requesting the numbering is refused.

2. The server machine according to claim 1, wherein
whether or not there is the right for requesting the numbering is confirmed depending on whether or not the mail address of the sender of said e-mail is a pre-registered mail address.

3. The server machine according to claim 1, wherein
whether or not there is the right for requesting the numbering is confirmed depending on whether or not said e-mail includes an ID issued beforehand.

4. The server machine according to claim 3, wherein
a term of validity is set for said ID; and
a numbering request with an ID expired is refused.

5. The server machine according to claim 1 further comprising:
an extracting unit that extracts items of registration for said numbering ledger, stated in a preset form in said e-mail including said numbering command, and for registering the extracted items of registration in said numbering ledger.

6. A business system including a server machine according to claim 1 and a plurality of client machines each of which is capable of sending an e-mail including a numbering command to said server machine;
said business system monistically managing a document or a file by an automatic numbering function.

7. An automatic numbering method comprising:
providing a server machine including a numbering management unit that carries out automatic numbering for an electronic numbering ledger; and
providing a plurality of client machines each of which is capable of sending an e-mail including a numbering command to said server machine;
confirming, by said server machine, whether or not an e-mail sent from a client machine is sent from a client machine having a right to request the numbering, based on information included in said e-mail;
analyzing, by said server machine, an e-mail sent from said client machine confirmed to have been sent from the client machine having the right to request the numbering, and registering on said numbering ledger based on the numbering command in said e-mail to acquire the result of automatic numbering; and
sending, by said server machine, the result of automatic numbering to the client machine as the sender of the e-mail including said numbering command; provided that a numbering request from a client machine not having the right to request the numbering is refused.

8. The automatic numbering method according to claim 7, wherein
whether or not there is the right for requesting the numbering is confirmed depending on whether or not the mail address of the sender of said e-mail is a pre-registered mail address.

9. The automatic numbering method according to claim 7, wherein
whether or not there is the right for requesting the numbering is confirmed depending on whether or not an ID issued beforehand is included in said e-mail.

10. The automatic numbering method according to claim 9, wherein
a term of validity is set for said ID; and
a numbering request with an ID expired is refused.

11. The method according to claim 7 further comprising:
extracting, by said server machine, contents of registration in said numbering ledger stated in a preset form in said e-mail including said numbering command, and registering the extracted contents of registration in said numbering ledger.

12. A numbering management program; said program allowing a server machine, connected to a plurality of client machines, each of which is capable of transmitting an e-mail including a numbering command, to perform a processing comprising:
analyzing an e-mail transmitted from one of said client machines, registering in said numbering ledger based on a numbering command contained in said e-mail; and
acquiring the result of automatic numbering, and a processing of sending the result of the automatic numbering to the client machine as the sender of the e-mail including the numbering command; wherein
said program further comprises: confirming whether or not an e-mail sent from a client machine has been sent from a client machine having a right to request numbering, based on information included in the e-mail sent from said client machine; wherein
only an e-mail confirmed to have been sent from the client machine having the right to request the numbering is analyzed, provided that a request for numbering from a client machine not having the right to request the numbering is refused.

13. The numbering management program according to claim 12, wherein
whether or not there is the right for requesting the numbering is confirmed depending on whether or not a mail address of a sender of an e-mail is a pre-registered mail address.

14. The numbering management program according to claim 12, wherein
whether or not there is the right for requesting the numbering is confirmed depending on whether or not said e-mail includes an ID issued beforehand.

15. The numbering management program according to claim 14, wherein
a term of validity is set for said ID; and
a numbering request with an ID expired is refused.

16. The numbering management program according to claim 12, wherein
said server carries out extracting contents of registration in said numbering ledger stated in a preset form in said e-mail including said numbering command and registering extracted contents of registration in said numbering ledger.
